(19) United States
(12) Patent Application Publication
(10) Pub. No.: US 2014/0109477 A1
(43) Pub. Date: Apr. 24, 2014

(54) Self-watering portable gardening bucket

(71) Applicant: Kenneth Ted Goodson, JR., Green Mountain, NC (US)

(72) Inventor: Kenneth Ted Goodson, JR., Green Mountain, NC (US)

(21) Appl. No.: 13/507,842

(22) Filed: Oct. 22, 2012

(51) Int. Cl. A01G 9/02

(52) U.S. Cl. CPC A01G 9/02
USPC 47/65.7

(57) ABSTRACT

The Gardening Bucket is a portable, self-watering plastic container. The design is shown with a 5 gallon container, filled at the bottom with a water-wicking hydroponics styrofoam material. The design has an external watering port, allowing the plant to be watered from the bottom of the container, and allowing the water to be absorbed by the plant through the hydroponics material as the plant needs water.

The item is constructed from a 5 gallon plastic bucket, a one inch ninety degree slip/threaded pvc fitting, a romex nut, and hydroponics Styrofoam seed tray.

The overall height is 15 inches, the diameter is 10 inches

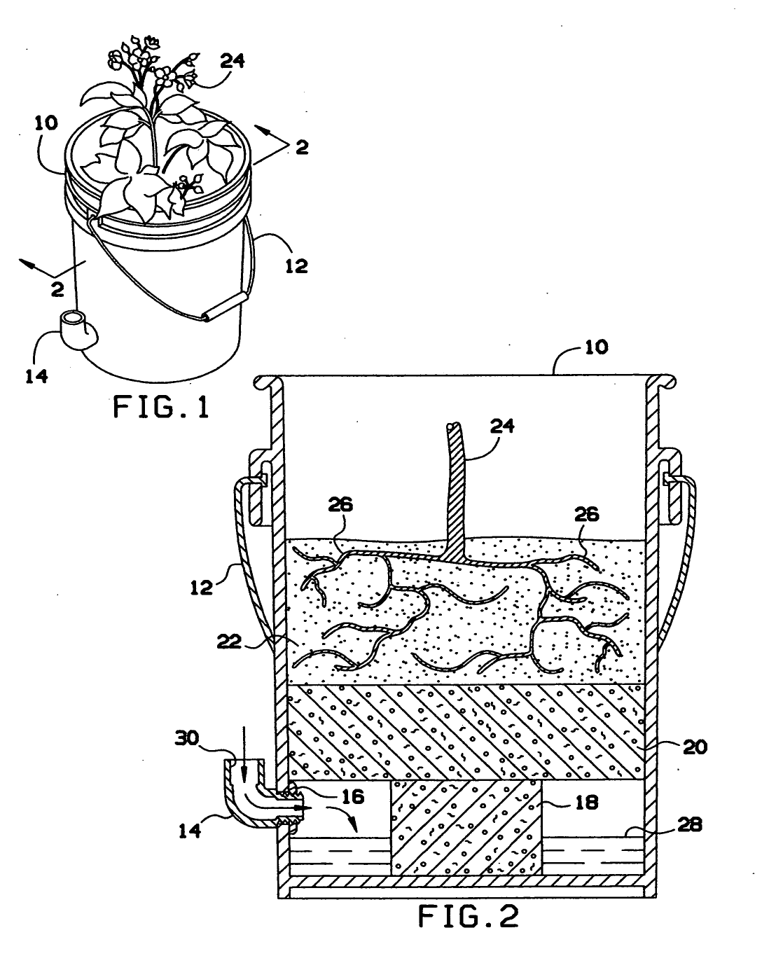

FIG. 1: is a perspective view

FIG. 2: is a section view

I claim the utility design for the gardening bucket as shown

1. A self-watering portable gardening bucket, constructed of lightweight plastic and hydroponics Styrofoam materials.

2. A bucket as in claim 1 that is self-watering
1. A bucket that is watered through a port located on the outside of the bucket
2. A bucket that waters plants as they need it
3. A bucket that uses a wicking material (hydroponics Styrofoam)

3. A bucket as in claim 2 that keeps disease away from plants
1. A bucket as in claim 2 that keeps excess water away from plant
2. A bucket as in claim 2 that using a wicking action to disperse water to plant only when needed
3. A bucket as in claim 2 that allows a view of water level in port
4. A bucket as in claim 2 that has a release port to prevent over watering
